(19) United States
(12) Patent Application Publication
(10) Pub. No.: US 2007/0128942 A1
(43) Pub. Date: Jun. 7, 2007

(54) SMART CARD CONNECTOR WITH A HOLDING STRUCTURE

(76) Inventor: Jin-Fei LI, (US)

Correspondence Address: Kao H. Lu, 1425 E. Darby Rd., Havertown, PA, 19083, US

(21) Appl. No.: 11/462,836

(22) Filed: Aug. 7, 2006

(30) Foreign Application Priority Data
Dec. 2, 2005 (TW) 094220994

(51) Int. Cl. H01R 24/00

(52) U.S. Cl. 439/630

(57) ABSTRACT

A smart card connector with a holding structure is disclosed, the card connector comprises an insulative housing, a plurality of elastic terminals and a holding structure. The terminals and the insulative housing are insert-molded directly in a mold, all the terminals are disposed on the same side of the connector, then the holding structure is mounted on two sides of the insulative housing, thus an integral smart card connector is formed. When the card connector is assembled on a circuit board, firstly inserting the board lock of the holding structure into the circuit board to make the solder portion of the elastic terminal contacted with the circuit board, and then proceeding with the connector soldering operation, thus the smart card has better stability when the card is inserted in.

### BACKGROUND OF THE INVENTION

1. Field of the Invention

The present invention generally relates to a smart card connector, especially to a smart card connector which is designed with a holding structure on two sides thereof.

2. Description of Related Art

With the fast development of wireless communication, mobile phone and personal digital assistant (PDA) is stricter to the requirements of smart card connector. The existing smart card connector comprises an insulative housing, a plurality of elastic terminals and an outer shell. The insulative housing has a plurality of terminal receiving grooves for setting the elastic terminals therein and connecting with a circuit board, the insulative housing and the outer shell define a retention chamber for accommodating a smart card therein, by electrically connecting the contact portions of the elastic terminals with the corresponding conductive portions of the inserted smart card, to achieve a connecting function with the smart card. But such a design would result in the following defects. The defects are that the volume of the modern smart card connector is becoming more and more tiny, the terminals are disposed within the insulative housing in inserting mode, this would make it difficult to control the depth of disposing the terminals in the terminal grooves, and would result in assembly inconvenience and encounter comparatively much more assembly time and cost. Furthermore, the conventional smart card connector is designed with an outer shell and uses a closed design which makes the clasp-holding structure thereof as an integral, which would not only occupy too much room on the circuit board, but also would have difficulty in assembly and inserting the card, and so on. Besides, the card connector is fixed on the circuit board by soldering the terminals on the circuit board, which would result in looseness between the terminals and the circuit board after times of insertion.

On account of the above adverse factors, it is necessary to develop a new smart card connector to meet the requirements of the modern industry.

### SUMMARY OF THE INVENTION

The primary object of the present invention is to provide a smart card connector with a holding structure, by means of designing a pair of holding members clasped on two sides of the insulative housing and inserting and soldering the holding members to the circuit board to securely ensure stable soldering between the terminals and the circuit board.

Another object of the present invention is to provide a smart card connector with a holding structure, which has a pair of separate complementary holding members, by way of the holding member to provide a smart card connector which can spare the limited space on the circuit board and can be easier for inserting the smart card.

The further object of the present invention is to provide a smart card connector with a holding structure, wherein the elastic terminals and the insulative housing are formed integrally to simplify the assembly of the terminals and to reduce the depth of the insulative housing so as to achieve the object of reducing the assembly time and the production cost.

To achieve the above objects, the present invention provides a smart card connector, which comprises an insulative housing, a plurality of terminals and a holding structure. The insulative housing and the elastic terminals are formed integrally, on the center of the two side guarding edges of the insulative housing each is disposed with a recess portion, which projects a plurality of protrusions, on the upper and lower sides of the protrusion each having an oblique section, the protrusions are adapted to engage with the grooves on the holding member. The solder portions of the elastic terminals are all disposed in a side of the insulative housing having no guarding edge, the solder portion of the elastic terminal is bent, the oblique design of the bent solder portion will has a cushioning effect and makes the connector and the circuit board can be engaged with each other tightly when the hook portion of the holding member is inserted into the circuit board. The holding structure is divided into two separate and relatively complementary holding members, which are similar in shape but opposite in bending direction, in reverse states. Each holding member is a rectangular shape structure with an opening on one side consisting of a side wall designed with a plurality of grooves and upper and lower walls designed with a sliding section. The holding member and the protrusions of the insulative housing can be elastically engaged with each other by sliding through the sliding sections and/or the oblique sections thereof, the upper and lower ends of the protrusion abutting against the upper and lower walls of the holding member, thus enable the holding member to be engaged with the insulative housing tightly. The lower wall of the holding member has a plurality of downwardly bent hook portions on both ends thereof, the hook portion is like an arrow, which is a structure adapted to engage with the circuit board for increasing the fixing effect of the connector.

From the above descriptions, using the smart card connector of the present invention which is designed with a pair of separate holding members, it can not only provide additionally a more stable soldering force with the circuit board, but also can safeguard the soldering between the terminals and the circuit board from being destroyed by the inserting force. Furthermore, by using the design of the holding member, it also can make the connector be more easy to assemble and be more easy for inserting the smart card. Beside, the elastic terminals and the insulative housing are formed integrally, which can simplify the assembly of the terminals and reduce the depth of the insulative housing so as to achieve the object of reducing the assembly time and the production cost.

The above and other objects, features and advantages of the present invention will become apparent from the following detailed description taken with the accompanying drawings.

### BRIEF DESCRIPTION OF THE DRAWINGS

FIG. 1 is a perspective view of a smart card connector of the present invention;

FIG. 2 is a perspective view of the insulative housing of the present invention;

FIG. 3 is a perspective view of the elastic terminals of the present invention; and

FIG. 4 is a perspective view of the holding structure of the present invention.

### DETAILED DESCRIPTION OF THE PREFERRED EMBODIMENTS

To better illustrate the present invention, a preferred embodiment with attached drawings is described hereinafter.

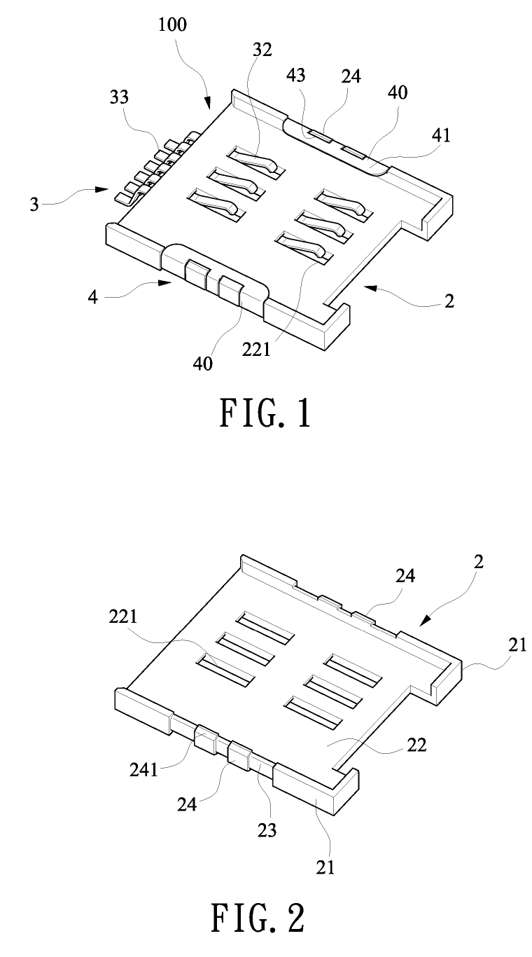

As shown in FIG. 1, the present invention is to provide a smart card connector 100, the connector 100 comprises an insulative housing 2, a plurality of terminals 3 and a holding structure 4 having two holding member 40. As shown in FIG. 2, the insulative housing 2 is formed of plastic material and like a flat plate body, on the three edges of the insulative housing 2 each extending a projected guarding edge 21, the three guarding edges 21 define a placing portion 22 for accommodating a smart card (not shown). When the smart card is retained in the placing portion 22, the guarding edge 21 has a function to block and locate the smart card in place. The placing portion 22 has a plurality of terminal receiving chambers 221 for accommodating the contact portions 32 of the terminals 3, the terminal receiving chamber 221 extending toward an end of the insulative housing 2 having no guarding edge 21 and forming an open channel, which is adapted to fasten the fixing portion 31 of the terminal 3 when the insulative housing 2 and the terminals 3 are integrally insert-molded, and through which the solder portion 33 of the terminal 3 is projected out of the insulative housing 2. The center of the two side guarding edges 21 of the insulative housing 2 is disposed with a recess portion 23, on which projects a plurality of protrusions 24, on the upper and lower sides of the protrusion 24 each having an oblique section 241, the protrusions 24 are adapted to engage with the grooves 43 on the holding member 40.

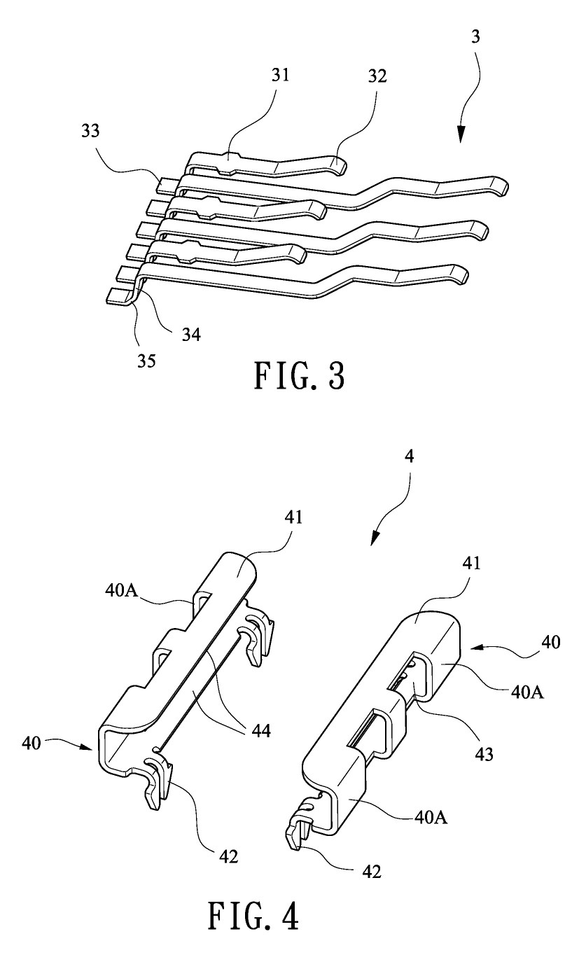

As shown in FIG. 3, the terminals 3 are made of conductive material and provided with appropriate elasticity. The terminals 3 have two shapes and each is formed with a fixing portion 31, a contact portion 32 and a solder portion 33 through a proper bending. The terminals 3 are disposed in the insulative housing 2 in advance, i.e. the terminals 3 and the insulative housing 2 are formed as an integral by means of insert-molding, wherein the fixing portion 31 is fastened within the channel of the insulative housing 2, the contact portion 32 connected to one end of the fixing portion 31 extends outward to the terminal receiving chamber 221 of the insulative housing 2 for connecting with the smart card, the solder portion 33 connected with another end of the fixing portion 31 extends out of the insulative housing 2, an oblique portion 35 connected between the solder portion 33 and the solder leg 34 thereof. The oblique portion 35 of the bent solder portion 33 will provide a well cushioning effect on the circuit board and make the connector and the circuit board to be engaged with each other tightly when the hook portion 42 of the holding member 4 is mated with the circuit board.

As shown in FIG. 4, the holding structure 4 is divided into left and right holding members 40, which are similar in shape but opposite in bending direction. Each of the holding members 40, which is a rectangular shape structure with an opening on one side, and the vertical side wall 40A is served as the main body, an end bending upward into a horizontal upper wall which is served as an anti-dislocating piece 41 which can prevent the smart card dislocating upward from the placing portion 22 and also has a function of shielding the smart card, another end bending downward into a horizontal lower wall which has a plurality of downwardly bent hook portions 42 on both ends thereof, the hook portion 42 is in a shape of arrow, which is a structure adapted to engage with the circuit board for increasing the fixing effect of the connector. On the side wall 40A of the holding member 40 is designed with a plurality of grooves 43, and on the inner surface of the upper and lower walls having a sliding section 44. The holding member 40 and the protrusions 24 of the insulative housing 2 can be elastically engaged with each other by sliding through the sliding sections 44 and/or the oblique sections 241 thereof, the upper and lower ends of the protrusion 24 abutting against the upper and lower walls of the holding member 40, thus enable the holding member 40 to be engaged with the insulative housing 2 tightly.

According to the present invention, the terminals 3 and the insulative housing 2 are insert-molded directly in a mold, all the terminals are disposed on the same side of the connector, then the holding structure 4 is mounted on two sides of the insulative housing 2, thus an integral smart card connector is formed. When the card connector is assembled on a circuit board, first inserting the hook portion 42 of the holding structure 4 in the circuit board (not shown) to make the solder portion 33 of the elastic terminal 3 contacted with the circuit board, then proceeding with the connector soldering operation, thus the smart card has better stability when the smart card is inserted therein.

While the invention herein disclosed has been described by means of specific embodiments, numerous modifications and variations could be made thereto by those skilled in the art without departing from the scope and spirit of the invention set forth in the claims.

What is claimed is:

1. A connector adapted to receive a smart card, the connector comprising:
an insulative housing having at least three edges, two of the edges of said insulative housing provided with a recess portion on a center thereof, each of the recess portion provided with a plurality of protrusions, an upper side and a lower side of each protrusion provided with a oblique section;
a plurality of elastic terminals integrally formed with said insulative housing, each provided with a solder portion, an oblique portion and a solder leg; and
a pair of elongated holding members each formed with an opening on one side having a side wall provided with the plurality of grooves, an upper wall and a lower wall, the upper wall and the lower wall of each holding member provided with a sliding section;
wherein said holding members are engaged with the protrusions of said insulative housing by the sliding sections and the oblique sections the lower wall of each said holding member is provided with a plurality of board locks downwardly bent therefrom.

2. The connector as recited in claim 1, wherein each of three edges of said insulative housing is provided with a projected guarding edge, the three guarding edges define a placing portion for accommodating the smart card.

3. The connector as recited in claim 1, wherein the solder legs of said elastic terminals are all disposed on one side having guarding edge of said insulative housing, the oblique portion connected between the solder portion and the solder leg thereof.
